(19) United States
(12) Patent Application Publication
(10) Pub. No.: US 2013/0015762 A1
(43) Pub. Date: Jan. 17, 2013

(54) PLASMA DISPLAY PANEL

(71) Applicants: Yusuke Fukui, Osaka (JP); Mikihiko Nishitani, Nara (JP); Masahiro Sakai, Kyoto (JP); Michiko Okafuji, Osaka (JP); Yayoi Okui, Osaka (JP); Yosuke Honda, Nara (JP); Yasuhiro Yamauchi, Osaka (JP); Osamu Inoue, Osaka (JP); Hiroshi Asano, Osaka (JP)

(72) Inventors: Yusuke Fukui, Osaka (JP); Mikihiko Nishitani, Nara (JP); Masahiro Sakai, Kyoto (JP); Michiko Okafuji, Osaka (JP); Yayoi Okui, Osaka (JP); Yosuke Honda, Nara (JP); Yasuhiro Yamauchi, Osaka (JP); Osamu Inoue, Osaka (JP); Hiroshi Asano, Osaka (JP)

(73) Assignee: PANASONIC CORPORATION, Osaka (JP)

(21) Appl. No.: 13/637,232

(22) PCT Filed: May 2, 2011
(86) PCT No.: PCT/JP2011/002544

§ 371 Date: Sep. 25, 2012

(30) Foreign Application Priority Data
May 7, 2010 (JP) 2010-107104

(51) Int. Cl. H01J 17/49

(52) U.S. Cl. 313/582

(57) ABSTRACT

There is provided a PDP in which the structure of the periphery of a protective film is improved, excellent secondary electron emission property is exhibited, and improved efficiency and increased life can be expected. There is further provided a PDP in which occurrence of a discharge delay at the time of driving is prevented, and exhibition of high quality image display performance can be expected even in a high definition PDP that is driven at a high speed. Specifically, a crystalline film containing Sr in CeO₂ in a concentration of 11.8 mol % to 49.4 mol % inclusive is formed on the surface of dielectric layer on the discharge space side as surface layer (protective film) having a thickness of about 1 μm. High γ fine particles having secondary electron emission property higher than those of protective film are arranged thereon.

### TECHNICAL FIELD

The present invention relates to a plasma display panel using radiation by gas discharge, and particularly to a technique for improving properties of the periphery of a surface layer (protective film).

### BACKGROUND ART

A plasma display panel (hereinafter referred to as a “PDP”) is a flat display device using radiation from gas discharge. Because of easy provision of high-speed display and upsizing, the PDP has been widely put into practical use in the fields of image display devices and public information display devices. The PDP is classified into a direct current type (DC type) and an alternating current type (AC type), but the surface-discharge type AC type PDP has an especially technical potential in terms of the life property and upsizing, and is commercialized.

FIG. 15 is a schematic assembly diagram showing a structure of general AC type PDP 1x. PDR 1x shown in FIG. 15 is configured by laminating front panel 2 and back panel 9. Front panel 2 as a first substrate is configured such that a plurality of display electrode pairs 6 each having a pair of scan electrode 5 and sustain electrode 4 are arranged on one surface of front panel glass 3, and dielectric layer 7 and protective film 8 are sequentially laminated so as to cover display electrode pairs 6. Scan electrode 5 and sustain electrode 4 are formed by laminating transparent electrodes 51, 41 and bus lines 52, 42, respectively.

Dielectric layer 7 is formed of low-melting glass having a glass softening point of about 550° C. to 600° C., and has a current limiting function specific to the AC type PDP.

Protective film 8 plays a role of protecting dielectric layer 7 and display electrode pairs 6 from ion collision in plasma discharge, and efficiently releasing secondary electrons to reduce a discharge starting voltage. Protective film 8 is usually formed by a vapor deposition method or a printing method using magnesium oxide (MgO) excellent in secondary electron emission property, sputtering resistance, and visible light transmittance. A structure similar to protective film 8 is provided as a surface layer intended solely for securing secondary electron emission property in some cases.

On the other hand, back panel 9 as a second substrate is configured such that a plurality of data (address) electrodes 11 for addressing image data on back panel glass 10 is arranged so as to orthogonally cross display electrode pairs 6 of front panel 2. On back panel glass 10, dielectric layer 12 composed of low-melting glass is arranged so as to cover data electrodes 11. On a boundary with a discharge cell (not shown) adjacent at dielectric layer 12, barrier rib (rib) 13 composed of low-melting glass and having a predetermined height is formed with a plurality of striped pattern parts 1231, 1232 combined in a lattice form so as to divide discharge space 15. Phosphor layer 14 (phosphor layers 14R, 14G, 14B) configured by coating phosphor inks of colors of R, G and B and firing the inks is formed on the surface of dielectric layer 12 and the side surface of barrier rib 13.

Front panel 2 and back panel 9 have display electrode pair 6 and data electrode 11 placed so as to orthogonally cross each other with discharge space 15 interposed therebetween, and sealed at each circumference thereof. At this time, internally closed discharge space 15 is filled at a pressure of several tens kPa with a rare gas such as a Xe—Ne type gas or Xe—He type gas as a discharge gas. In this way, PDP 1x is formed.

For displaying images on the PDP, a gradation system of dividing one-field image into a plurality of sub-fields (S. F.) (e.g., intra-field time-division display system) is used.

In these situations, low power driving is desired for recent electric appliances, and there exists a similar request for the PDP. In a PDP which provides high definition image display, the number of discharge cells increases as discharge cells are made smaller, and therefore the operating voltage must be increased for improving reliability of address discharge. The operating voltage of the PDP depends on the secondary electron emission coefficient (γ) of the protective film. A symbol γ is a value determined by a material and a discharge gas, and it is known that γ increases as the work function of a material decreases. An increase in operating voltage is a hindrance to low power driving.

Thus, PTL 1 discloses a protective film having SrO as a main component with CeO₂ mixed therein, and describes that SrO is caused to stably discharge electricity at a low voltage.

### CITATION LIST

### Patent Literature

PTL 1: Unexamined Japanese Patent Publication No. 52-116067

### SUMMARY OF THE INVENTION

### Problems to be Solved by the Invention

In any of the conventional techniques described above, however, it can hardly be said that actually low power driving of a PDP is achieved satisfactorily.

It is also the problem that a protective film containing CeO₂ requires a long aging time as compared to MgO.

Thus, the current PDP has several problems that can hardly be compatible, and is therefore susceptible to improvement.

The present invention has been made in view of the problems described above and as a first object, provides a PDP in which by improving the structure of the periphery of a protective film, excellent secondary electron emission property is exhibited, and improved efficiency and increased life can be expected.

As a second object, the present invention provides a PDP in which in addition to the effects described above, occurrence of a discharge delay at the time of driving is prevented, and exhibition of high quality image display performance can be expected even in a high definition PDP that is driven at a high speed.

### Solutions to the Problems

For achieving the objects described above, a PDP of one aspect of the present invention is a plasma display panel comprising: a first substrate on which a plurality of display electrodes is arranged; and a second substrate, the first substrate being placed opposite to the second substrate with a discharge space interposed therebetween, the first substrate and the second substrate being sealed with the discharge space filled with a discharge gas, wherein the first substrate has a protective film disposed on a surface facing the discharge space, the protective film made of CeO2 having Sr added to a concentration of 11.8 mol % to 49.4 mol % inclusive is formed, and the protective film is provided thereon with high γ fine particles having secondary electron emission property higher than secondary electron emission property of the protective film.

### Effects of the Invention

In a PDP of one aspect of the present invention having the structure described above, Sr adjusted to a predetermined concentration within the bounds of not increasing an aging time is further included in a protective film containing CeO₂. Consequently, in a band structure, a Sr-originated electronic level is formed in a forbidden band, and the position of the upper end of a valence band is elevated, so that electrons in the valence band exist at a relatively shallow level. Therefore, when the PDP is driven, a large amount of electrons existing at an impurity level and around the upper end of the valence band can be involved in electron discharge using energy available in the process of Auger neutralization by Xe atoms of a discharge gas and the like. Using the increased energy, secondary electron emission property of the protective film is considerably improved, so that in the PDP, discharge can be started in high responsivity at a relatively low discharge starting voltage, and the discharge delay can be prevented to exhibit excellent image display performance with low power driving.

The Sr-originated electron level is formed at a certain depth from a vacuum level (i.e., not too shallow depth in terms of energy). Therefore, occurrence of “charge-through” due to excessive disappearance of charges from the protective film at the time of driving is suppressed, appropriate charge retention property can be exhibited, and emission of secondary electrons improved over time can be expected.

If high γ fine particles having secondary electron emission property higher than secondary electron emission property of the protective film are arranged on the protective film, high γ fine particles make the way to expand discharge in an aging step of removing an impurity layer of hydroxides and carbonates covering the surface, so that impurities can be efficiently removed, and resultantly discharge is not localized but expands extensively to achieve a PDP having a high luminance, high efficiency and high reliability.

### BRIEF DESCRIPTION OF DRAWINGS

FIG. 1 is a sectional view showing a structure of a PDP of a first embodiment.

FIG. 2 is a view schematically showing a relationship between each electrode and a driver in the PDP of the first embodiment.

FIG. 3 is a view showing one example of a drive waveform of the PDP of the first embodiment.

FIG. 4 is a schematic view for explaining an electronic level of CeO₂ and a process of releasing secondary electrons in an Auger neutralization process.

FIG. 5 is a schematic view for explaining each electronic level and a process of releasing secondary electrons in an Auger neutralization process for a protective film of the PDP of the first embodiment and a protective film of a conventional PDP.

FIG. 6 is a partially enlarged view of the PDP for explaining a conventional problem.

FIG. 7 is a partially enlarged view of the PDP for explaining an effect of the present invention.

FIG. 8 is a sectional view showing a structure of a PDP of a second embodiment.

FIG. 9 is a graph showing the results of X-ray diffraction of samples with varied concentrations of Sr in CeO₂.

FIG. 10 is a graph showing a dependency on the concentration of Sr of the lattice constant determined by X-ray diffraction.

FIG. 11 is a graph showing a dependency on the concentration of Sr in CeO₂ of the ratio of carbonates to the surface determined by XPS measurement.

FIG. 12 is a graph showing a dependency of the discharge voltage on the concentration of Sr in CeO₂ when using a discharge gas containing Xe at a partial pressure of 15%.

FIG. 13 is a graph showing a dependency of the aging time on the concentration of Sr in CeO₂ when using a discharge gas containing Xe at a partial pressure of 15%.

FIG. 14 is a graph showing emission efficiency and the sputtering amount of a protective film in discharge for 1000 hours when using a discharge gas containing Xe at a partial pressure of 20%.

FIG. 15 is an assembly diagram showing a structure of a conventional general PDP.

### DESCRIPTION OF EMBODIMENTS

### Aspects of the Invention

A PDP of one aspect of the present invention is a plasma display panel comprising: a first substrate on which a plurality of display electrodes is arranged; and a second substrate, the first substrate being placed opposite to the second substrate with a discharge space interposed therebetween, the first substrate and the second substrate being sealed with the discharge space filled with a discharge gas, wherein the first substrate has a protective film disposed on a surface facing the discharge space, the protective film made of CeO2 having Sr added to a concentration of 11.8 mol % to 49.4 mol % inclusive is formed, and the protective film is provided thereon with high γ fine particles having secondary electron emission property higher than secondary electron emission property of the protective film.

Conventionally, a protective film containing CeO₂ has very low chemical stability, so that the surface of the protective film is hydroxylated or carbonated in a step of producing a PDP, leading to formation of a deterioration layer to degrade secondary electron emission (γ) property. The deterioration layer can be removed to some extent by carrying out a step of aging a PDP, but the difference in secondary electron emission property becomes significantly large between a region from which the deterioration layer has been removed and a region in which the deterioration layer remains. Consequently, discharge generated at the time of driving is localized only on the region from which the deterioration layer has been removed and does not expand to the region in which the degradation layer remains, and therefore both the luminance and efficiency of the PDP are reduced. It is also the problem that discharge locally generated within a discharge cell, whereby the protective film is excessively sputtered, resulting in a reduction in product life of the PDP.

Further, in the PDP, there exists the problem of the “discharge delay”. In the field of displays such as the PDP, image sources are moving into high definition, and the number of scan electrodes (scan lines) tends to be increased for display of high definition images. For example, in the full high-vision TV, the number of scan lines is double or more as compared to the NTSC type TV. For display of images on a high definition PDP, one-field sequence should be driven at a high speed within 1/60 [s]. For this purpose, there is a method of reducing the width of a pulse applied to a data electrode in an address period in a sub-field.

However, there is the problem of time lag called a “discharge delay” after a voltage pulse arises and before discharge is actually generated within the discharge cell at the time of driving the PDP. If the width of the pulse decreases due to high-speed driving, effects of the “discharge delay” increase to reduce the probability that discharge can be completed within the width of each pulse. As a result, unlit cells (lighting failure) occur on a screen to impair image display performance. Particularly, in a PDP having a protective film of amorphous structure as in PTL 1, initial electrons suppressing the discharge delay are hardly emitted, and therefore deterioration of image quality can be relatively significant.

In contrast, the above-mentioned PDP of one aspect of the present invention, Sr adjusted to a predetermined concentration within the bounds of not increasing an aging time is included in a protective film containing CeO₂. Consequently, in a band structure, a Sr-originated electronic level is formed in a forbidden band, and the position of the upper end of a valence band is elevated, so that electrons in the valence band exist at a relatively shallow level, so that, when the PDP is driven, a large amount of electrons existing at an impurity level and around the upper end of the valence band can be involved in electron discharge using energy available in the process of Auger neutralization by Xe atoms of a discharge gas and the like. Using the increased energy, secondary electron emission property of the protective film can be considerably improved, discharge can be started in high responsivity at a relatively low discharge starting voltage, and the discharge delay can be prevented to exhibit excellent image display performance with low power driving.

Further, the Sr-originated electron level is formed at a certain depth from a vacuum level (i.e., not too shallow depth in terms of energy). Therefore, occurrence of “charge-through”, in which charges excessively disappear from the protective film at the time of driving, is suppressed, appropriate charge retention property can be exhibited, and emission of secondary electrons improved over time can be expected.

Here, as another aspect of the present invention, the high γ fine particles may contain at least any of Ce, Sr and Ba.

As another aspect of the present invention, the concentration of Sr in the protective film may be 25.7 mol % to 42.9 mol % inclusive.

As another aspect of the present invention, it is also preferred to form the high γ fine particles with any of SrCeO₃, BaCeO₃ and La₂Ce₂O₇.

As another aspect of the present invention, MgO fine particles may be further arranged on the discharge space side of the protective film.

As another aspect of the present invention, the MgO fine particles may be prepared by a gas phase oxidation method. Alternatively, the MgO fine particles may be prepared by firing an MgO precursor.

As another aspect of the present invention, the discharge gas may contain Xe at a partial pressure of 15% or higher.

Hereinafter, embodiments and examples of the present invention will be described but as a matter of course, the present invention is not limited to the forms thereof, and may be appropriately modified without departing from the technical scope of the present invention.

### First Embodiment

### General Structure of PDP 1

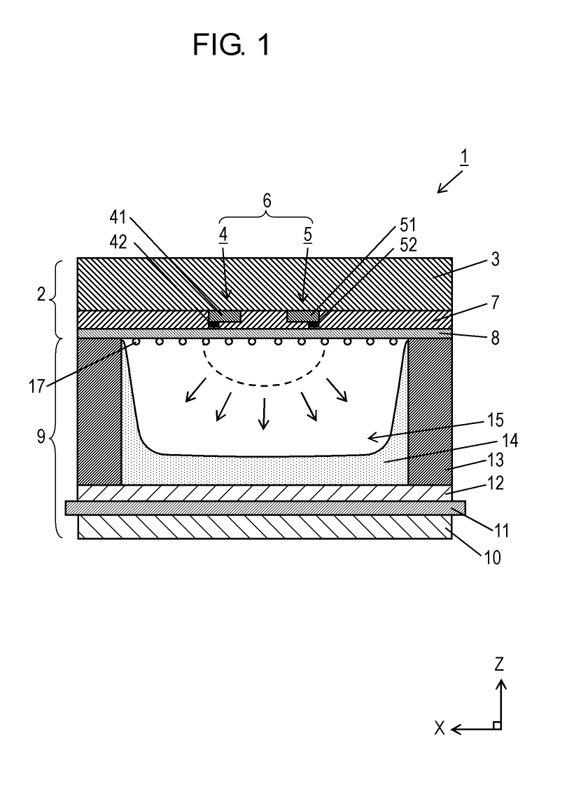

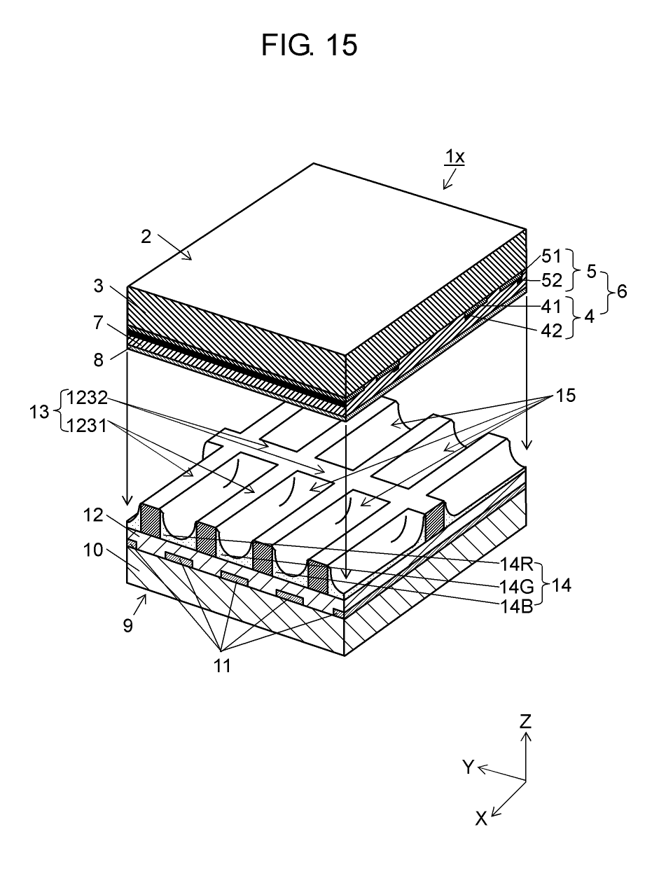

FIG. 1 is a schematic sectional view taken along the xz plane of PDP 1 of a first embodiment of the present invention. PDP 1 has a structure that is same as a conventional structure (FIG. 15) in general except for a structure of the periphery of protective film 8.

Here, PDP 1 is an AC type of the 42 inch class NTCS specification example, but the present invention may be applied to other specification examples such as XGA and SXGA as a matter of course. As a high definition PDP having a resolution higher than HD (High Definition), for example, the following specification can be shown. When the panel size is 37 inches, 42 inches, and 50 inches, the setting can be made to 1024×720 (pixel number), 1024×768 (pixel number) and 1366×768 (pixel number), respectively. In addition, a panel having a resolution higher than that of the HD panel can be included. As the panel having a resolution higher than HD, a full HD panel having 1920×1080 (pixel number) can be included.

As shown in FIG. 1, the structure of PDP 1 is classified broadly into a first substrate (front panel 2) and a second substrate (back panel 9), the main surfaces of which are disposed oppositely to each other.

On one main surface, of front panel glass 3 that is the substrate of front panel 2, a plurality of display electrode pairs 6 (scan electrode 5, sustain electrode 4), the electrodes of which are arranged with a predetermined discharge gap (75 μm) interposed therebetween, are formed. Each display electrode pair 6 is configured by laminating bus lines 52, 42 (thickness: 7 μm, width: 95 μm) composed of an Ag thick film (thickness: 2 μm to 10 μm), an Al thin film (thickness: 0.1 μm to 1 μm), a Cr/Cu/Cr laminate thin film (thickness: 0.1 μm to 1 μm) or the like to belt-shaped transparent electrodes 51, 41 (thickness: 0.1 μm, width: 150 μm) composed of transparent conductive material such as indium tin oxide (ITO), zinc oxide (ZnO), tin oxide (SnO₂) or the like. The sheet resistances of transparent electrodes 51, 41 are reduced by bus lines 52, 42.

Here, the “thick film” refers to a film formed by various kinds of thick film formation methods in which a conductive material-containing paste or the like is coated and then fired to form a film. The “thin film” refers to a film formed by various kinds of thin film formation methods using vacuum processes including a sputtering method, an ion plating method, and an electron beam vapor deposition method.

On the entire main surface, of front panel glass 3 on which display electrode pairs 6 are arranged, dielectric layer 7 of low-melting glass (thickness: 35 μm) having lead oxide (PbO) or bismuth oxide (Bi₂O₃) or phosphorous oxide (PO₄) as a main component is formed by a screen printing method or the like.

Dielectric layer 7 has a current limiting function specific to the AC type PDP, and a factor for achieving life improvement as compared to the DC type PDP.

Here, protective film 8 is arranged on the surface of dielectric layer 7 and predetermined high γ fine particles 17 are arranged on the surface of protective film 8. The structure of the periphery of protective film 8 is a main characteristic part of the first embodiment.

Protective film 8 is composed of a thin film having a thickness of about 1 μm. The film is composed of a material excellent in sputtering resistance and secondary electron emission coefficient γ for protecting dielectric layer 7 from ion impacts at the time of discharge and reducing a discharge starting voltage. Further satisfactory optical transparency and electrical insulating property are required for the material.

Protective film 8 in PDP 1 is configured by adding Sr to CeO₂, a main component, in a concentration range of 11.8 mol % to 49.4 mol % inclusive, and is a crystalline film retaining at least any of a microcrystal structure and a crystal structure of CeO₂ in general. Ce is added for forming an electron level in the forbidden band of protective film 8 as described later. It has been found that a still further preferred concentration of Sr is 25.7 mol % to 42.9 mol % inclusive. By adding an appropriate amount of Sr element, protective film 8 exhibits satisfactory secondary electron emission property and charge retention property, so that operating voltages (mainly discharge starting voltage and discharge retaining voltage) of PDP 1 can be reduced to perform stable driving.

If the concentration of Sr is significantly lower than 11.8 mol %, secondary electron emission property and charge retention property of protective film 8 become unsatisfactory, and it takes a long time for aging, thus being not preferable. If the concentration of Sr is significantly higher than 49.4 mol %, the crystal structure of protective film 8 is changed from a fluorite structure possessed by CeO₂ to an amorphous structure or a NaCl structure possessed by SrO, so that surface stability possessed by CeO₂ is deteriorated, satisfactory secondary electron emission property is not exhibited, and further an aging time for removing surface contaminants increases. Therefore, as a concentration of Sr for achieving satisfactory both low power driving and reduction of the aging time, the concentration range of 11.8 mol % to 49.4 mol % inclusive is important.

For the structure of protective film 8, a peak equal in position to that of pure CeO₂ can be observed in a thin film X-ray analysis measurement using a CuKα ray as a radiation source, and therefore it can be confirmed that at least a fluorite structure similar to that of CeO₂ is retained. Since the ion radius of Sr is significantly different from the ion radius of Ce, the CeO₂-based fluorite structure is collapsed if the concentration of Sr in protective film 8 is high (the added amount of Sr is too large), but in the present invention, the crystal structure (fluorite structure) of protective film 8 is retained by appropriately adjusting the concentration of Sr.

High γ fine particles 17 arranged on protective film 8 will now be described. High γ fine particles 17 has secondary electron emission property higher than secondary electron emission (γ) property of underlying protective film 8, and is configured by including at least any of, for example, Ce, Sr and Ba. As a specific example, high γ fine particles 17 are composed of an oxide containing at least any of Ce, Sr and Ba (any of SrCeO₃, BaCeO₃ and La₂Ce₂O₇). By providing, on the surface of the protective film, high γ fine particles 17 having such property, a discharge region is effectively expanded at the time of aging, so that PDP 1, which can be satisfactorily driven at a low driving voltage and has a high luminance and high efficiency, can be provided. The oxide containing at least any of Ce, Sr and Ba is also a constituent element of protective film 8 (Ba exists as a main impurity of SrCeO₃ of a raw material of protective film 8). Consequently, even if oxide particles 17 are sputtered and thereby re-deposited on protective film 8 at the time of discharge, no significant composition variation occurs in protective film 8, and the discharge voltage is not increased. Therefore, in PDP 1, driving at a stable discharge voltage can be achieved even when it is driven for a long time.

On one main surface, of back panel glass 10 that is the substrate of back panel 9, data electrodes 11 composed of any of an Ag thick film (thickness: 2 μm to 10 μm), an Al thin film (thickness: 0.1 μm to 1 μm), a Cr/Cu/Cr laminate thin film (thickness: 0.1 μm to 1 μm) and the like are provided side by side with a width of 100 μm in a striped form at fixed intervals (360 μm) in the γ direction with the x direction as a longitudinal direction. Dielectric layer 12 having a thickness of 30 μm is arranged on the entire surface of back panel glass 10 so as to cover data electrodes 11.

On dielectric layer 12, lattice-shaped barrier ribs 13 (height: about 110 μm, width: 40 μm) are further arranged in accordance with the gap of adjacent data electrodes 11, and play a role of preventing occurrence of false discharge and optical crosstalk by dividing a discharge cell.

On the side surfaces of two adjacent barrier ribs 13 and the surface of dielectric layer 12 therebetween, phosphor layer 14 corresponding to each of red (R), green (O), and blue (B) is formed for color display. Dielectric layer 12 is not essential, but data electrodes 11 may be enclosed by phosphor layer 14 directly.

Front panel 2 and back panel 9 are oppositely placed such that the longitudinal directions of data electrode 11 and display electrode pair 6 orthogonally cross each other, and outer circumference parts of both panels 2 and 9 are sealed by a glass frit. A discharge gas composed of inert gas components including He, Xe, Ne and the like is filled between both panels 2 and 9 at a predetermined pressure.

Discharge space 15 extends between barrier ribs 13, and a region where adjacent one display electrode pair 6 and one data electrode 11 cross each other with discharge space 15 held therebetween corresponds to a discharge cell (also referred to as “sub-pixel”) involved in image display. The discharge cell pitch is 675 μm in the x direction and 300 μm in the y direction. One pixel (675 μm×900 μm) is configured by adjacent three discharge cells corresponding to colors of RGB.

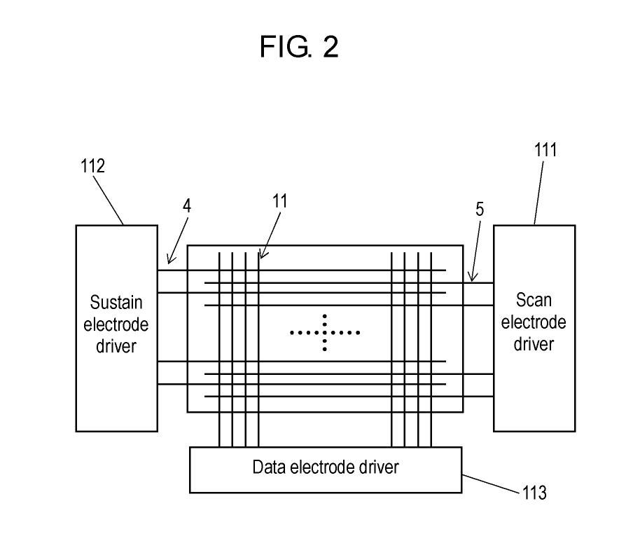

Scan electrode driver 111, sustain electrode driver 112, and data electrode driver 113 are connected as a driving circuit to each scan electrode 5, sustain electrode 4, and data electrode 11, respectively, outside the panel as shown in FIG. 2.

(Example of Driving PDP)

PDP 1 having the structure described above has AC voltages of several tens kHz to several hundreds kHz applied to gaps between display electrode pairs 6 by a known driving circuit (not shown) including drivers 111 to 113 at the time of driving. Consequently, discharge is generated within any discharge cell, and phosphor layer 14 is irradiated with an ultraviolet ray which mainly includes a resonance line having principally a wavelength of 147 nm from excited Xe atoms and a molecular beam having principally a wavelength of 172 nm from excited Xe molecules (dotted line and arrow in FIG. 1). Phosphor layer 14 is excited to emit visible light. The visible light is transmitted through front panel 2 and radiated over the front face.

As one example of the driving method, an intra-field time-division display system is employed. The system divides a displayed field into a plurality of sub-fields (S. F.) and further divides each subfield into a plurality of periods. One sub-field is further divided into four periods: (1) an initializing period for initializing all discharge cells; (2) an address period for addressing each discharge cell and selecting/inputting a display state corresponding to input data to each discharge cell; (3) a sustain period for causing discharge cells in a displayed state to provide luminous display; and (4) an elimination period for eliminating wall charges formed by sustain discharge.

In each sub-field, wall charges on the entire screen are reset by an initializing pulse through the initializing period, address discharge for accumulating wall charges is then carried out only on discharge cells to be lit in the address period, and alternating-current voltages (sustain voltages) are simultaneously applied to all discharge cells in the subsequent discharge sustain period to thereby sustain discharge for a fixed period of time to provide luminous display.

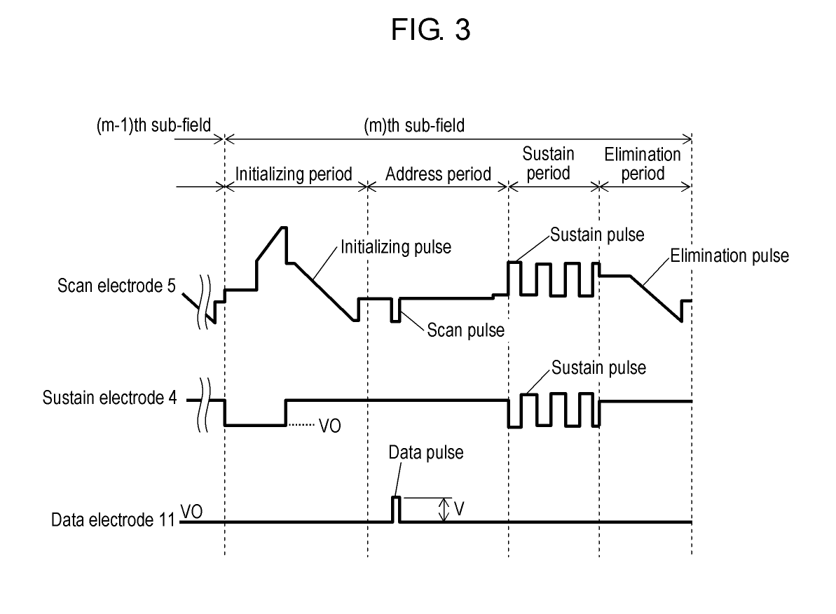

Here, FIG. 3 illustrates a drive waveform applied to PDP 1, and shows a drive waveform in the mth sub-field in the field. In this example, each sub-field is assigned the initializing period, the address period, the discharge sustain period, and the elimination period.

The initializing period is a period for eliminating wall charges on the entire screen (initializing discharge) to prevent influences of previous lighting of discharge cells (influences of accumulated wall charges). In the example of the drive waveform shown in FIG. 3, a high voltage (initializing pulse) is applied to scan electrode 5 as compared to data electrode 11 and sustain electrode 4 to cause a gas in the discharge cell to discharge electricity. Charges thus generated are accumulated on the wall surface of the discharge cell so as to eliminate a difference in potential among data electrode 11, scan electrode 5, and sustain electrode 4, so that negative charges are accumulated as wall charges on the surface of protective film 8 around scan electrode 5. Positive charges are accumulated as wall charges on the surface of phosphor layer 14 around data electrode 11 and the surface of protective film 8 around sustain electrode 4. By the wall charges, a wall potential of a predetermined value is generated between scan electrode 5 and data electrode 11 and between scan electrode 5 and sustain electrode 4.

The address period is a period for performing addressing of selected discharge cells on the basis of an image signal divided into sub-fields (setting of lighting/non-lighting). In the period, a low voltage (scan pulse) is applied to scan electrode 5 as compared to data electrode 11 and sustain electrode 4 when the discharge cell is lit. That is, a voltage is applied between scan electrode 5 and data electrode 11 in the same direction as the wall potential and a data pulse is applied between scan electrode 5 and sustain electrode 4 in the same direction as the wall potential to generate address discharge. Consequently, negative charges are accumulated on the surface of phosphor layer 14 and the surface of protective film 8 around sustain electrode 4, and positive charges are accumulated as wall charges on the surface of protective film 8 around scan electrode 5. In this way, a wall potential of a predetermined value is generated between sustain electrode 4 and scan electrode 5.

The discharge sustain period is a period for expanding a lit state set by address discharge to sustain discharge for securing a luminance corresponding to a grey level. Here, in a discharge cell having the wall charge, a voltage pulse (e.g., rectangular wave voltage of about 200 V) for sustain discharge is applied to each electrode of a pair of scan electrode 5 and sustain electrode 4 at a phase different from each other. Consequently, pulse discharge is generated for each change in voltage polarity to a discharge cell in which a displayed state is addressed.

Due to the sustain discharge, a resonance line having a wavelength of 147 nm is radiated from excited Xe atoms in the discharge space, and a molecular beam having principally a wavelength of 173 nm is radiated from excited Xe molecules. The surface of phosphor layer 14 is irradiated with the resonance line and molecular beam to provide luminous display by emission of visible light. Multi-color/multi-tone display is provided by combination of sub-field units for each color of RGB. In a non-discharge cell in which no wall charge is addressed in protective film 8, no sustain discharge is generated to provide black display as a displayed state.

In the elimination period, an elimination pulse of a progressive reduction type is applied to scan electrode 5, whereby wall charges are eliminated.

(Decrease in Discharge Voltage)

The reason why PDP 1 of the first embodiment having the above-mentioned structure can be driven at a low voltage as compared to the conventional PDP will be described.

The discharge voltage of the PDP is generally determined by the amount of electrons emitted from the protective film (electron emission property). Electron emission process of the protective film is dominantly a process in which Ne (neon) and Xe (xenon) of the discharge gas composition are excited at the time of driving, and energy by Auger neutralization is received, whereby secondary electrons are emitted from the protective film.

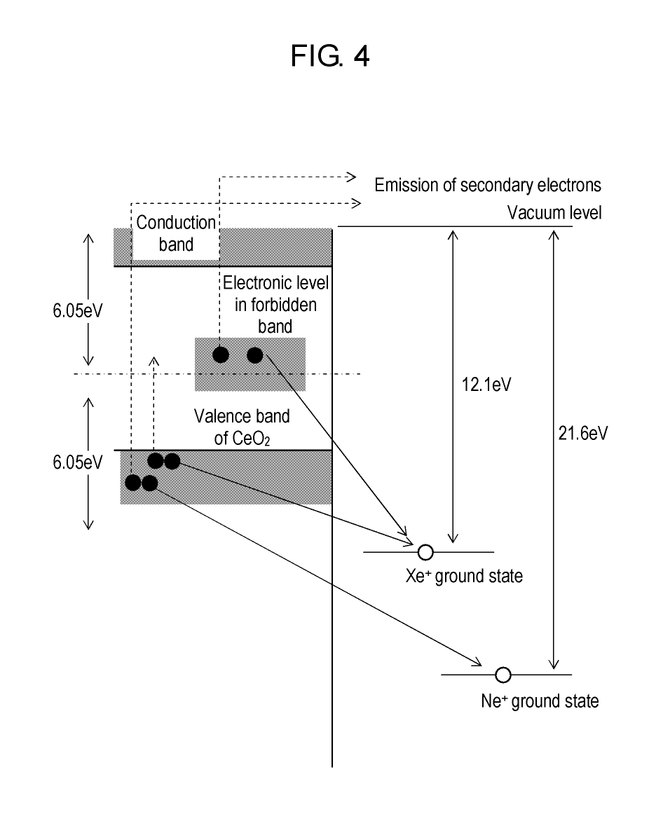

FIG. 4 is a schematic view showing a band structure of a protective film composed of CeO₂ and an electronic level. As shown in the figure, electrons existing on the periphery of a valence band in the protective film are heavily involved in electron emission in the protective film.

In the case of using Ne of relatively high ionization energy for the discharge gas composition, electrons are brought down into their ground states when Ne atoms are excited at the time of driving (electrons at the right end in FIG. 4). Energy (21.6 eV) at this time is received by electrons existing in the valence band in the protective film through Auger neutralization. The amount of energy (21.6 eV) exchanged in this process is sufficient for electrons existing in the valence band to be emitted as secondary electrons.

However, the amount of energy that can be received in the process of Auger neutralization by electrons in the valence band in the protective film when electrons are brought down into their ground states when Xe atoms are excited at the time of driving in the case of using Xe or relatively low ionization energy for the discharge gas composition is small (12.1 eV) as compared to the case of Ne atoms described above, and therefore cannot be sufficient for satisfactorily releasing electrons from the protective film. Thus, the probability of emission of secondary electrons becomes so low that consequently the operating voltage outstandingly increases as the Xe partial pressure in the discharge gas rises. This becomes a serious problem when the Xe partial pressure in the discharge gas is increased for increasing the luminance of the PDP.

Here, generally, in a band structure of a protective film composed of CeO₂, there exists in a forbidden band of CeO₂ an electronic level considered as Ce4f, which can satisfactorily receive an effect of Auger neutralization as shown in FIG. 4. The use of electrons existing at the relatively shallow electronic level makes it relatively easy to emit electrons from the protective film even by energy obtained in the process of Auger neutralization by Xe atoms, so that the probability of emission of secondary electrons is increased, and consequently the driving voltage for the PDP can be reduced. However, the number of electrons existing at the electronic level considered as Ce4f is extremely low as compared to the number of electrons in the valence band, and the electronic level itself is not stable. Therefore, the effect of reducing the discharge voltage is insufficient, and there still exists a problem in sustaining stable discharge property for a long period of time.

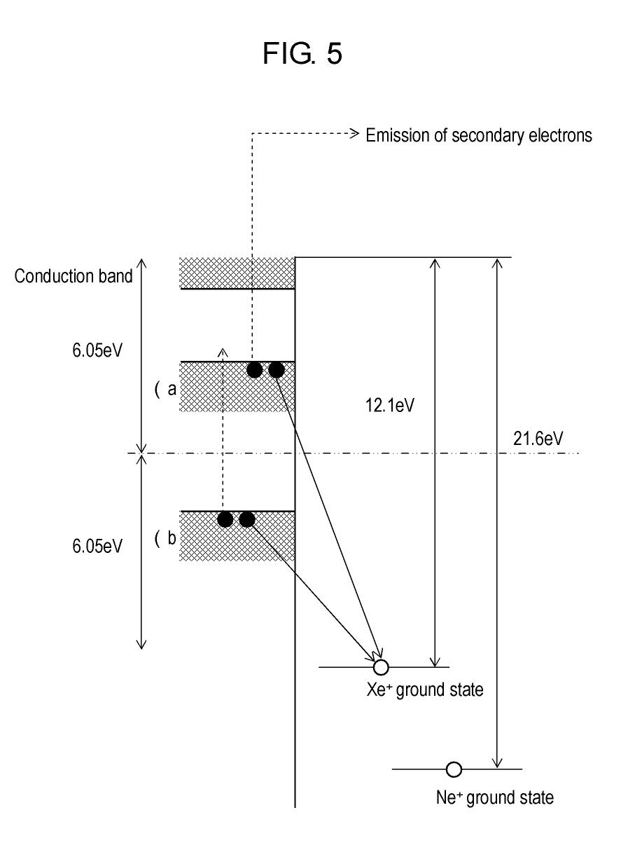

Thus, as a composition of protective film 8 of PDP 1, Sr is added to CeO₂, and its concentration (ratio of the number of moles of Sr to the total number of moles of Sr and Ce) is controlled to 11.8 mol % to 49.4 mol % inclusive to achieve additional low voltage discharge. The effect thereof will be described with reference to FIG. 5. In the protective film 8, an appropriate amount of Sr is added to form an impurity level in the forbidden band, and the position of the upper end of the valence band is raised from position (b), which is a conventional position in CeO₂, to position (a). By raising the position of the upper end of the valence band, the amount of electrons emitted from the protective film by energy that can be obtained in the process of Auger neutralization at the time of driving (probability of emission of secondary electrons) is increased, so that the discharge voltage can be efficiently reduced. Moreover, in this case, electrons, which are involved in Auger neutralization and emitted, include not only a small amount of electrons existing at the impurity level but also a large amount of electrons existing in the stable valence band, and therefore enriched secondary electron emission property lasting for a long period of time can be expected.

For conditions allowing such an effect to be obtained in particular, it has been found from experiments by the present inventors that it is more preferable to control the added amount of Sr to 25.7 mol % to 42.9 mol % inclusive.

(Improvement of Luminance, Efficiency, and Reliability)

The reason why the luminance, efficiency, and reliability are improved by arranging fine particles containing at least any of Ce, Sr and Ba as high γ fine particles 17 will now be described.

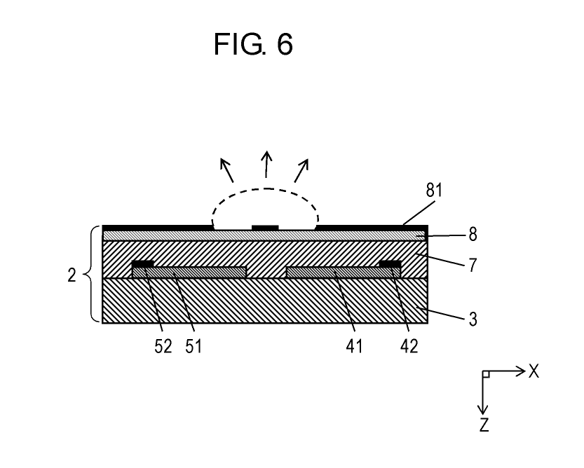

FIG. 6 shows a partially enlarged view (block diagram of the vicinity of a front panel at the time of driving) of a PDP for explaining a conventional problem. Generally, a protective film composed of a material having high secondary electron emission property has poor surface stability and the surface is hydroxylated and carbonated in a process of preparing a PDP. Consequently, the surface of the protective film is covered with hydroxylated and carbonated deterioration layer 81 to compromise secondary electron emission property. Such deterioration layer 81 can be removed to a certain degree by actually carrying out an aging step at the end stage of a production step to generate discharge in a discharge space. In the aging step, a very high voltage is applied, so that relatively strong discharge is generated at the inside parts of a sustain electrode and a scan electrode (vicinity of a main discharge region) where electric fields are most intensively focused as shown by a dotted line and arrows in FIG. 6. By the strong discharge, as shown in FIG. 6, deterioration layer 81 in the vicinity of the main discharge regions is removed, protective film 8 covered with deterioration layer 81 is partially exposed to discharge space 15, and the discharge voltage outstandingly decreases. However, as long as the state shown in FIG. 6 is kept, protective film 8 is exposed, so that only the vicinity of the main discharge region having improved secondary electron emission property can contribute to discharge, and discharge hardly expands to other wide regions covered with deterioration layer 81 (discharge cell regions having low secondary electron emission property). In this state, ion collision occurs only in regions where electric fields are focused, and sputtering by discharge is localized on the regions, resulting in reduction of product life of the PDP.

On the other hand, for improving the luminance and efficiency of the PDP, vacuum ultraviolet light by excitation of Xe should be efficiently generated, but in the state of FIG. 6 in which discharge regions do not expand, vacuum ultraviolet light is not efficiently generated, and improvement of the luminance and efficiency cannot be expected. Therefore, for achieving all of luminance improvement, efficiency improvement, and reliability improvement of the PDP, localization of discharge described above should be prevented.

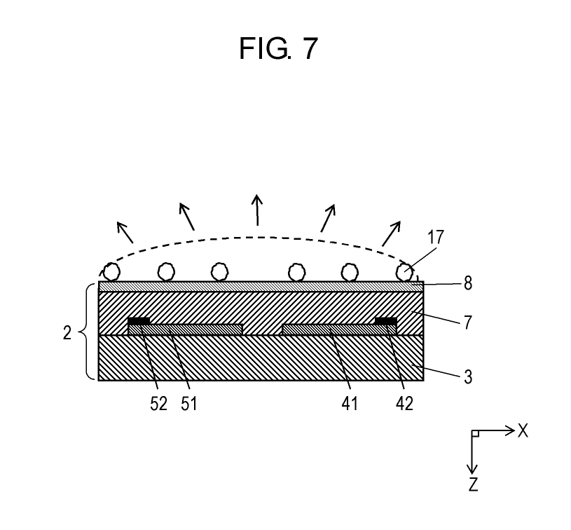

In PDP 1, this problem is solved by arranging high γ fine particles 17. FIG. 7 shows a partially enlarged view (block diagram of the vicinity of a front panel at the time of driving) of a PDP 1 at the time of driving. In FIG. 7, high γ fine particles 17 arranged on protective film 8 are schematically represented in a size larger than it actually is for the sake of explanation. In PDP 1, by arranging high γ fine particles 17 on the surface of protective film 8, high γ fine particles 17 exhibit a certain protective effect to protective film 8, and direct deposition of impurities on the surface of protective film 8 can be prevented. Consequently, formation of deterioration layer 81 over a wide area of protective film 8 as in conventional cases can be suppressed.

By arranging high γ fine particles 17, electric field-focused parts are distributed not only on the vicinity of the main discharge region between display electrodes 4 and 5, but also on sharp parts of high γ fine particles 17 due to the shape effect when discharge is generated in the discharge space in the aging step. Consequently, as shown by a dotted line and arrows in the figure, generated discharge is not localized, but uniformly expands over the entire discharge cell. Consequently, deterioration layer 81, which cannot be removed when high γ fine particles 17 are not provided (state in FIG. 6), can be efficiently removed, and efficiency improvement by a satisfactory discharge scale can be expected after completion of PDP 1. Ce, Sr and Ba, which are constituent elements of high γ fine particles 17, can increase the probability of emission of secondary electrons by Auger neutralization as described above, so that secondary electron emission property of protective film 8 is not compromised by arrangement of high γ fine particles 17. Further, constituent elements (Ce, Sr and Ba) of high γ fine particles 17 are also constituent elements of protective film 8, and therefore even if high γ fine particles 17 are sputtered by discharge and re-deposited on protective film 8, a change in composition of the vicinity of protective film 8 is insignificant. Therefore, in PDP 1, stable discharge property is obtained even by discharge for a long period of time.

For the reasons described above, in PDP 1, the discharge scale at the time of driving can be expanded to exhibit properties such as a high luminance, high efficiency, and high reliability for a long period of time.

Particularly, in PDP 1, efficiency can be improved, so that for example, when Xe at a partial pressure of 15% or more is added in the composition of a discharge gas, a PDP having a satisfactory luminance and high efficiency can be achieved.

### Second Embodiment

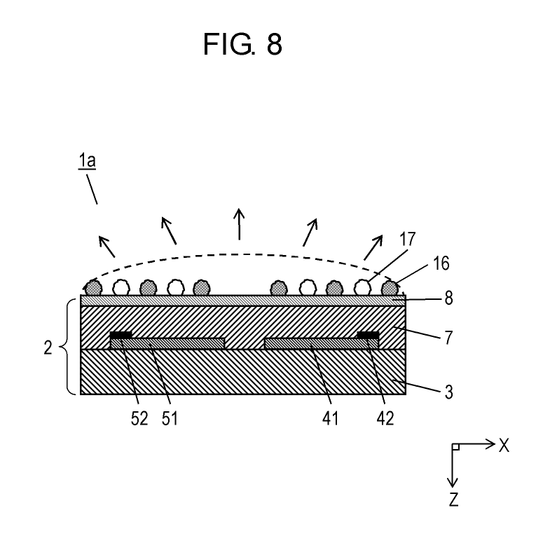

A second embodiment of the present invention will be described mainly about differences as compared to the first embodiment. FIG. 8 is a partially enlarged view (block diagram of the vicinity of a front panel at the time of driving) showing a structure of PDP 1a according to the second embodiment.

The basic structure of PDP 1a is similar to that of PDP 1, but is characteristic in that MgO fine particles 16 having high initial electron emission property are dispersed and arranged together with high γ fine particles 17 on the surface of protective film 8 facing discharge space 15. The dispersed densities of high γ fine particles 17 and MgO fine particles 16 can be set such that protective film 8 is not directly seen when the protective film in discharge cell 20 is two-dimensionally viewed from the Z direction, but are not limited thereto. For example, the particles may be partially provided, or may be provided only at positions corresponding to display electrode pairs 6.

The mixing ratio of high γ fine particles 17 and MgO fine particles 16 can be appropriately adjusted, and they may be mixed at a ratio of, for example, 1:1. Further, the average particle diameters of high γ fine particles 17 and MgO fine particles 16 can also be appropriately adjusted.

In FIG. 8, high γ fine particles 17 and MgO fine particles 16 arranged on protective film 8 are schematically represented in a size larger than it actually is for the sake of explanation. MgO fine particles 16 may be prepared by any of a gas phase method and a precursor firing method. However, it has been found from experiments that if the particles are prepared by the precursor firing method described later, MgO fine particles 16 having especially satisfactory can be obtained.

In PDP 1a having this structure, the property of protective film 8 and MgO fine particles 16 and high γ fine particles 17 which are mutually functionally separated are synergistically exhibited.

That is, at the time of driving, secondary electron emission property is improved by protective film 8 containing Sr in a concentration of 11.8 mol % to 49.4 mol % inclusive to reduce the operating voltage like PDP 1, leading to achievement of low power driving. By improvement of charge retention property, the secondary electron emission property is stably sustained over time during driving.

Due to provision of high γ fine particles 17, efficiency can be improved by suppressing concentrated discharge on protective film 8 in an aging step and effectively removing deterioration layer 81. Even if high γ fine particles 17 sputtered by discharge at the time of driving are re-deposited on protective film 8 after completion of PDP 1a, a change in composition is kept low, and long life can be expected.

Further, in PDP 1a, initial electron emission property is improved by MgO fine particles 16 arranged along with high γ fine particles 17. Consequently, discharge responsivity is dramatically improved, and a PDP, in which problems concerning the discharge delay and a dependency on temperature of the discharge delay are alleviated, can be achieved. This effect is effective in obtaining excellent image display performance particularly in a PDP which has high definition cells and is driven at a high speed by a narrow-width pulse.

Further, by arranging MgO fine particles 16, direct deposition of impurities on the surface of protective film 8 from discharge space 15 can be prevented, and further improvement of life performance of the PDP can be expected.

(MgO Fine Particles 16)

From experiments conducted by the present inventor of the present application, MgO fine particles 16 provided in PDP 1a have been to have an effect of suppressing the “discharge delay” mainly in address discharge and an effect of improving a dependency of the “discharge delay” on temperature. Therefore, in the second embodiment, MgO fine particles 16 are arranged on the surface of protective film 8 as an initial electron emission part at the time of driving taking advantage of such a nature that these particles have excellent high-level initial electron emission property as compared to protective film 8.

It is considered that the main cause of the “discharge delay” is an insufficient amount in which initial electrons serving as a trigger are emitted into discharge space 15 from the surface of protective film 8 at the time of starting discharge. Thus, for effectively contributing to initial electron emission property to discharge space 15, MgO fine particles 16, of which the initial electron emission amount is much greater than that of protective film 8, are dispersively arranged on the surface of protective film 8. Consequently, initial electrodes required in an address period are emitted in a large amount from MgO fine particles 16 to eliminate the discharge delay. By obtaining such initial electron emission property, PDP 1a can be driven at a high speed with satisfactory discharge responsivity even in the case of high definition and the like.

Further, it has been found that as a structure in which these MgO fine particles 16 are arranged on the surface of protective film 8, an effect of improving a dependency of the “discharge delay” on temperature is obtained in addition to an effect of suppressing the “discharge delay” mainly in address discharge.

In this way, in PDP 1a, by combining protective film 8 exhibiting effects of low power driving, secondary electron emission property, charge retention property and the like with MgO fine particles 16 exhibiting an effect of suppressing the discharge delay and a dependency thereof on temperature, high-speed driving can be performed at a low voltage even in the case of having high definition discharge cells and high-quality image display performance with suppressed occurrence of unlit cells can be expected as PDP 1 in general.

Further, MgO fine particles 16 are laminated and provided on the surface of protective film 8 and thereby have a certain protective effect for protective film 8 along with high γ fine particles 17. Protective film 8 has a high secondary electron emission coefficient, and enables low power driving of the PDP, but has a nature of relatively high adsorptivity of water and impurities such as carbon dioxide or hydrocarbon. When impurities are adsorbed, initial property of discharge such as secondary electron emission property is compromised. Thus, if this protective film 8 is covered with both high γ fine particles 17 and MgO fine particles 16, deposition of impurities on the surface of protective film 8 from discharge space 15 can be effectively prevented. Consequently, improvement can also be expected for life property of the PDP. High γ fine particles 17 and MgO fine particles 16 both have satisfactory actions for emission of secondary electrons as described above, and therefore discharge properties are not degraded.

Method for Production of PDP

A method for production of PDP 1 and PDP 1a in the embodiments described above will now be described. PDP 1 and PDP 1a are different only in type of fine particles arranged on protective film 8, and same for other production steps.

(Preparation of Back Panel)

On the surface of back panel glass 10 having a thickness of about 2.6 mm and composed of soda lime glass, a conductive material having Ag as a main component is coated in a striped form at fixed intervals by a screen printing method to form data electrode 11 having a thickness of several μm (e.g., about 5 μm). As an electrode material of data electrode 11, metals such as Ag, Al, Ni, Pt, Cr, Cu and Pd, materials such as conductive ceramics such as carbides and nitrides of various kinds of metals, or any combination thereof, or laminate electrodes formed by lamination thereof can be used as required.

Here, for matching PDP 1 to be prepared with the 40 inch class NTSC standard or VGA standard, the interval between adjacent two data electrodes 11 is about 0.4 mm or less.

Subsequently, on the entire surface of back panel glass 10, on which data electrode 11 is formed, a glass paste composed of lead-based or non-lead-based low-melting glass and SiO₂ is coated in a thickness of about 20 μm to 30 μm and fired to form dielectric layer 12.

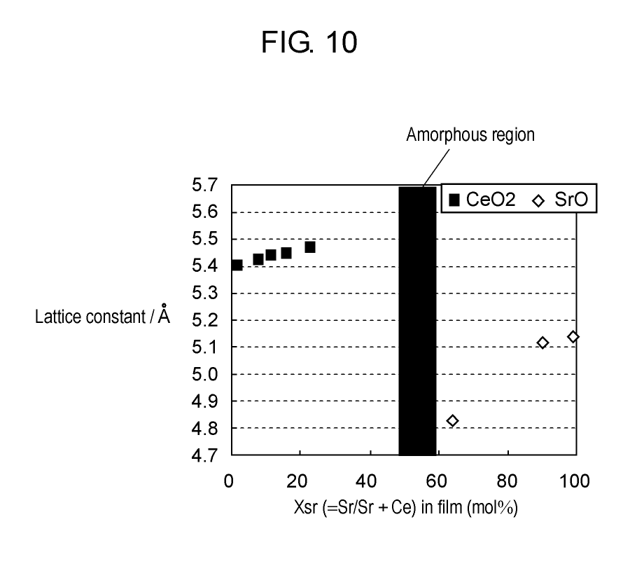

Next, barrier ribs 13 are formed on dielectric layer 12 in a predetermined pattern. A low-melting glass material paste is coated, and a plurality of arrangements of discharge cells is formed in a lattice-shaped pattern of partitioning lines and rows (see FIG. 10) so as to partition circumferences of boundaries with adjacent discharge cells (not shown) using a sand blast method or a photolithography method.

When barrier ribs 13 can be formed, then wall surfaces of barrier ribs 13 and a surface of dielectric layer 12 exposed between barrier ribs 13 are coated with a fluorescent ink containing any of a red (R) phosphor, a green (G) phosphor and a blue (B) phosphor, which is usually used in the AC type PDP. The coated ink is dried/fired to form phosphor layer 14 (14R, 14G, 14B), respectively.

An example of chemical compositions of applicable phosphors of colors of RGB is as follows.

Red phosphor; (Y, Gd)BO₃:Eu

Green phosphor; Zn₂SiO₄:Mn

Blue phosphor; BaMgAl₁₀O₁₇:Eu

The form of each phosphor material is preferably a powder having an average particle diameter of 2.0 μm. The powder is placed in a server in a ratio of 50% by mass, 1.0% by mass of ethyl cellulose, and 49% by mass of solvent (α-Terpineol) are added, and the mixture is stirred and mixed by a sand mill to prepare a phosphor ink of 15×10⁻³ Pa·s. The phosphor ink is coated by injecting the ink to between barrier ribs 13 through nozzles having a diameter of 60 μm by a pump. At this time, the panel is moved in the longitudinal direction of barrier rib 20 to coat the phosphor ink in a striped form. Thereafter, the coated ink is fired at 500° C. for 10 minutes to form phosphor layer 14.

In this way, back panel 9 is completed.

In the method described above, front panel glass 3 and back panel glass 10 are composed of soda lime glass, but this is mentioned as one example of materials, and the panel glasses may be composed of other materials.

(Preparation of Front Panel 2)

Display electrode pairs 6 are prepared on the surface of front panel glass 3 having a thickness of about 2.6 mm and composed of soda lime glass. Here, an example of forming display electrode pairs 6 by a printing method is shown, but they may be formed by other methods such as a die coating method and blade coating method.

First, a transparent electrode material such as ITO, SnO₂, or ZnO is coated on the front panel glass with a final thickness of about 100 nm in a predetermined pattern such as a striped pattern, and dried. Consequently, a plurality of transparent electrodes 41, 51 is prepared.

On the other hand, a photosensitive paste configured by mixing a photosensitive resin (photodegradable resin) with an Ag powder and an organic vehicle is prepared, repeatedly coated on transparent electrodes 41, 51, and covered with a mask having a pattern of a display electrode to be formed. The coated paste is exposed to light through the mask, made to undergo a developing step, and fired at a firing temperature of about 590° C. to 600° C. Consequently, bus lines 42, 52 having a final thickness of several μm are formed on transparent electrodes 41, 51, and display electrode pairs 6 are thus formed. According to this photomask method, bus lines 42, 52 can be narrowed to a line width of about 30 μm as compared to the screen printing method with which the line width can no longer be reduced to less than 100 μm conventionally. As a metal material of bus lines 42, 52, Pt, Au, Al, Ni, Cr, tin oxide, indium oxide or the like can be used besides Ag. Bus lines 42, 52 can be formed not only by the method described above, but also by forming an electrode material into a film by a vapor deposition, a sputtering method or the like, followed by carrying out an etching treatment.

Next, a paste prepared by mixing lead-based or non-lead-based low-melting glass having a softening point of 550° C. to 600° C. or a SiO₂ material powder and an organic binder composed of butyl carbitol acetate and the like is coated on formed display electrode pairs 6. The coated paste is fired at about 550° C. to 650° C. to form dielectric layer 7 having a final thickness of several μm to several tens μm.

(Preparation of Protective Film 8)

First, formation of protective film 8 by an electron beam vapor deposition method will be described.

A pellet for a vapor deposition source is prepared. As a method for preparing the pellet, first a CeO₂ powder is mixed with a Sr carbonate powder, which is a carbonate of an alkali earth metal element, and the mixed powder is placed in a mold and pressure-molded. Thereafter, the molded material is placed in an alumina crucible, and fired in the air at a temperature of about 1400° C. for about 30 minutes to obtain a sintered body (pellet).

The sintered body or pellet is placed in a vapor deposition crucible of an electron beam vapor deposition apparatus, and protective film 8 containing Sr in CeO₂ in a concentration of 11.8 mol % to 49.4 mol % inclusive is formed on the surface of dielectric layer 7 using the pellet as a vapor deposition source. Adjustment of the Sr concentration is carried out by controlling the mixing ratio of CeO₂ and Sr carbonate at a stage for obtaining a mixed powder to be placed in an alumina crucible. Consequently, the protective film of PDP 1 is completed.

For the method for forming protective film 8, not only an electron beam vapor deposition method but also a known method such as a sputtering method or an ion plating method can be similarly applied.

A method for preparing high γ fine particles containing at least Ce, Sr and Ba will now be described.

(Preparation of High γ Fine Particles 17)

For preparing high γ fine particles 17, CeO₂, Sr carbonate, and Ba carbonate are used as raw material powders. Powders of CeO₂, Sr carbonate, Ba carbonate, La₂O₃, SnO and the like, which contain at least one of the above-mentioned substances and do not hinder secondary electron emission property as a mixed powder, are selected, and a powder prepared by mixing these powders is placed in an alumina crucible, and fired in the air at a temperature of about 1400° C. for about 30 minutes. Consequently, high γ fine particles 17 containing a composition of the selected mixed powders are obtained.

High γ fine particles 17 obtained by the method described above are dispersed in a solvent. The dispersion liquid is dispersively spread over the surface of protective film 8 according to a spray method, a screen printing method, or an electrostatic coating method. Thereafter, the solvent is removed through a drying/firing process to fix high γ fine particles 17 on the surface of protective film 8.

By the method above, high γ fine particles 17 can be arranged on protective film 8 of PDP 1.

On the other hand, when PDP 1a is produced, MgO fine particles 16 and high γ fine particles 17 are arranged on protective film 8 by a method same as that described above. Here, MgO fine particles 16 can be produced by any of the gas phase synthesis method and the precursor firing method below.

Gas Phase Synthesis Method

A magnesium metal material (purity: 99.9%) is heated under an atmosphere filled with an inert gas. While this heated state is sustained, a small amount of oxygen is introduced into the atmosphere, and magnesium is thus directly oxidized to thereby prepare MgO fine particles 16.

Precursor Firing Method

An MgO precursor illustrated below is uniformly fired at a high temperature (e.g., 700° C. or higher), and annealed to obtain MgO fine particles. As the MgO precursor, for example, any one or more of magnesium alkoxide (Mg(OR)₂), magnesium acetylacetone (Mg(acac)₂), magnesium hydroxide (Mg(OH)₂), magnesium carbonate, magnesium chloride (MgCl₂), magnesium sulfate (MgSO₄), magnesium nitrate (Mg(NO₃)₂) and magnesium oxalate (MgC₂O₄) may be selected (two or more thereof may be mixed and used). There may be a case where a selected compound is normally in the form of a hydrate, and such a hydrate may be used.

A magnesium compound that is an MgO precursor is adjusted so that the purity of MgO obtained after firing is 99.95% or more, and 99.98% more as an optimum value. This is because if impurity elements such as various kinds of alkali metals, B, Si, Fe and Al are mixed in a magnesium compound in a certain amount or more, undesired adhesion between particles and sintering occur at the time of heat treatment, and thus high crystalline MgO fine particles are difficult to obtain. Therefore, the precursor is adjusted beforehand by, for example, removing impurity elements.

High-quality MgO fine particles 16 can be obtained by carrying out any of the methods described above.

(Completion of PDP)

Fabricated front panel 2 and back panel 9 are laminated together using sealing glass. Thereafter, the interior of discharge space 15 is evacuated to a high degree of vacuum (about 1.0×10⁻⁴ Pa), and filled with a discharge gas such as a Ne—Xe-based, He—Ne—Xe-based or Ne—Xe—Ar-based gas at a predetermined pressure (here 66.5 kPa to 101 kPa). Here, in the present invention, protective film 8 having the above-mentioned composition and high γ fine particles 17 are provided, and therefore a high-efficiency PDP can be obtained even if Xe is filled at a partial pressure of 15% or higher.

PDP 1 or PDP 1a is completed through the steps described above.

(Experiments for Confirming Performance)

Subsequently, PDPs of following samples 1 to 24 mutually different only in the structure of the periphery of protective film 8 were prepared for confirming performance of PDPs according to the present invention.

As a method for describing the amount of Sr in a film (protective film) having principally CeO₂, a ratio of the number of atoms represented by Sr/(Sr+Ce)*100 (hereinafter described as “X_{Sr}”) was used. The unit of X_{Sr} can be represented by any of (%) and (mol %) with the numerical value unchanged, but will be represented by (mol %) hereinafter for the sake of convenience.

Samples 1 to 10 (Reference Examples 1 to 10) correspond to the structure of PDP 1 of the first embodiment.

Among them, samples 1 to 4 (Reference Examples 1 to 4) have protective films having Sr added to CeO₂ with X_{Sr} being 11.8 mol %, 15.7 mol %, 22.7 mol %, and 49.4 mol %, respectively.

Sample 11 (Reference Example 11) has predetermined MgO fine particles arranged on a protective film. Specifically, sample 11 (Reference Example 11) is configured such that a protective film having Sr added to CeO₂ with X_{Sr} being 49.4 mol % is formed, and MgO fine particles prepared by a precursor firing method are dispersively arranged thereon.

On the other hand, sample 12 (Comparative Example 1) is a PDP of the most basic conventional structure and has a protective film formed by EB vapor deposition and composed of magnesium oxide (containing no Ce).

Samples 13 and 14 (Comparative Examples 2 and 3) have protective films having Sr added to CeO₂ with X_{Sr} being 1.6 mol % and 8.4 mol %, respectively.

Samples 15 to 20 (Comparative Examples 4 to 9) have protective films having Sr added to CeO₂ with X_{Sr} being 54.9 mol %, 63.9 mol %, 90.1 mol %, 98.7 mol %, 99.7 mol %, and 100 mol %, respectively.

Samples 21 to 23 (Examples 1 to 3) have predetermined fine particles of SrCeO₃, BaCeO₃, and La₂Ce₂O₇ arranged on protective films, respectively, and correspond to the structure of the first embodiment. Specifically, in samples 21 to 23 (Examples 1 to 3), Sr is added to CeO₂, protective films having X_{Sr} of 42.9 mol % are provided, and fine particles of SrCeO₃, BaCeO₃, and La₂Ce₂O₇ are dispersively arranged thereon, respectively.

Samples 24 (Example 4) has predetermined fine particles of SrCeO₃ arranged on a protective film of sample 11 (Reference Example 11) and corresponds to the structure of the second embodiment. Specifically, sample 24 (Example 4) is configured such that Sr is added CeO₂, a protective film having X_{Sr} of 42.9 mol % is formed, and fine particles of SrCeO₃ are dispersively arranged thereon.

The structure of the periphery of the protective film for each of samples 1 to 24 and experimental data using the samples are shown together in Tables 1 to 3 below.

[Table 1]

[Table 2]

[Table 3]

Experiment 1

Evaluation of Film Properties (Analysis of Crystal Structure)

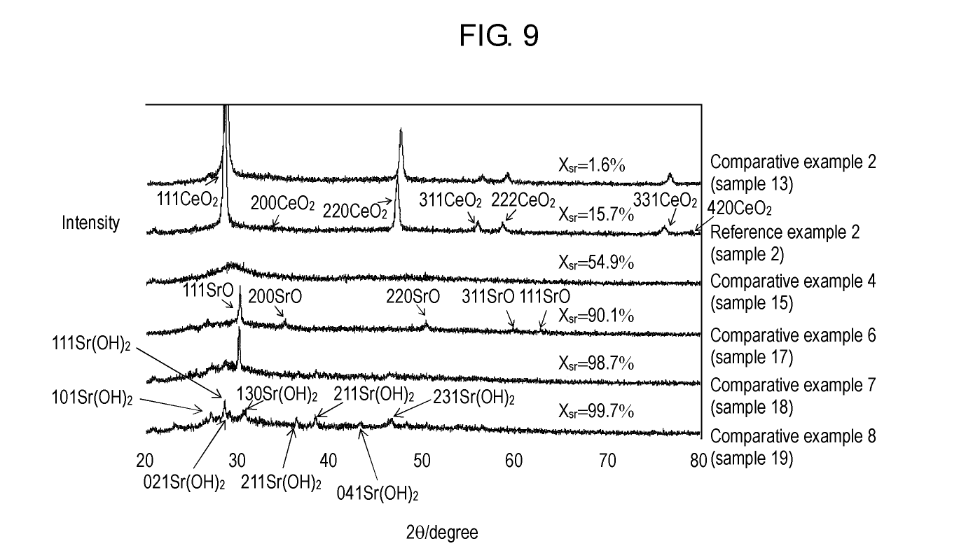

Results through θ/2θ X-ray diffraction measurements for examining crystal structures (phase states) of the samples described above are shown in FIG. 9, and analysis results are shown in Tables 1 to 3. In FIG. 9 are shown profiles of samples having X_{Sr} of 1.6 mol %, 15.7 mol %, 54.9 mol %, 90.1 mol %, 98.7 mol % and 99.7 mol % (samples 13, 2, 15, 17, 18 and 19, respectively).

In FIG. 9, it has been found that only CeO₂ having a fluorite structure exists in samples having a relatively low X_{Sr} of 1.6 mol % and 15.7 mol % (samples 13 and 2).

Next, for a protective film having X_{Sr} of 54.9 mol % (sample 15), no peak can be observed from the measurement results in FIG. 9. Based on the fact that no peak can be observed, the structure of the sample is considered to be non-crystalline (amorphous). This is thought to be because the crystal structure of the protective film changes from a fluorite structure to a NaCl structure as X_{Sr} increases, but in a certain range including the value of X_{Sr} in sample 15, the film cannot have either of the crystal structures, loses its crystallinity, and therefore becomes amorphous.

On the other hand, in a protective film having X_{Sr} of about 98 mol % and containing a large amount of Sr (sample 18), a peak of Sr(OH)₂ is detected. This is considered to be because the protective film that is SrO just after formation is exposed to the air before or during a measurement, whereby hydroxylation proceeds. Thus, it has been found that if X_{Sr} is about 98 mol % or more, the surface stability of the protective film is extremely deteriorated.

In contrast to sample 18, a protective film having X_{Sr} of 90.1 mol % (sample 17) has been found to have a single-layer structure of SrO. From this, it is found that if SrO is added to Ce in an amount of about 10 mol %, hydroxylation of SrO can be prevented and the surface stability is improved.

Next, the lattice constant of each structure was determined by the result through X-ray diffraction to examine a dependency of X_{Sr} on the lattice constant. The results are shown in FIG. 10.

It has been found from the results shown in FIG. 10 that a protective film having X_{Sr} in a range of about 0 mol % to 30 mol % has a crystal structure of CeO₂, and the lattice constant increases in proportion to an increase in X_{Sr}. This indicates that when at least X_{Sr} is in a range of no more than 30 mol %, Sr is dissolved in CeO₂. An increase in the lattice constant can also be explained if considering the fact that the ion radius of Sr is larger than the ion radius of Ce.

On the other hand, a protective film having X_{Sr} in a range of 60 mol % to 100 mol % has been found to have a crystal structure of SrO.

A protective film having X_{Sr} in a range of 50 mol % to 60 mol % has an amorphous region which does not have any of the crystal structures.

From these results, X_{Sr} should be lower than 50 mol % for having a fluorite structure as a crystal structure.

Experiment 2

Evaluation of Surface Stability

Generally, if a large amount of carbonate is contained in a protective film, secondary electron emission property specific to the protective film cannot be obtained, and resultantly the operating voltage increases. For avoiding this problem, an aging step for causing a PDP before shipment to discharge for a certain period of time to remove contaminants on a protective film becomes necessary. Since the aging step is desired to be completed in short time if considering the productivity of the PDP, it is preferable to reduce the amount of carbonate in a protective film as much as possible before the aging step.

Thus, as experiment 2, the stability of the surface of a protective film was examined for each sample having a carbonate as an impurity included in a protective film composed of MgO. As a method thereof, the amount of carbonate included in a surface of the protective film was measured according to X-ray photoelectron spectroscopy (XPS). The protective film of each sample was exposed to the air for a certain period of time after formation, placed on a plate for measurement, and introduced into a XPS measurement chamber. Since it was thought that a carbonation reaction of the film surface would constantly proceed during exposure to the air, an air exposure time required for the setting was set to 5 minutes for equalizing process conditions among samples.

“QUANTERA” manufactured by ULVAC-PHI, Inc. was used for a XPS measurement apparatus. For an X-ray source, Al—Kα was used, and a monochrometer was used. An experimental sample, which is an insulator, was neutralized by a neutralization gun and an ion gun. Measurements were made by 30 cycles of integration of energy regions corresponding to Mg2p, Ce3d, C1s, and O1s, and the composition ratio of each element in the film surface was determined from the peak area and sensitivity coefficient of the obtained spectrum. The C1s spectral peak was subjected to waveform separation into a spectral peak detected at near 290 eV and a spectral peak of C and CH detected at near 285 eV, the ratio of each spectrum was determined, and the amount of CO in the film surface was determined from a product of the composition ratio of C and the ratio of CO therein. By the amount of CO in the film determined through XPS, a comparison was made for the stability, i.e., the degree of carbonation, of the film surface.

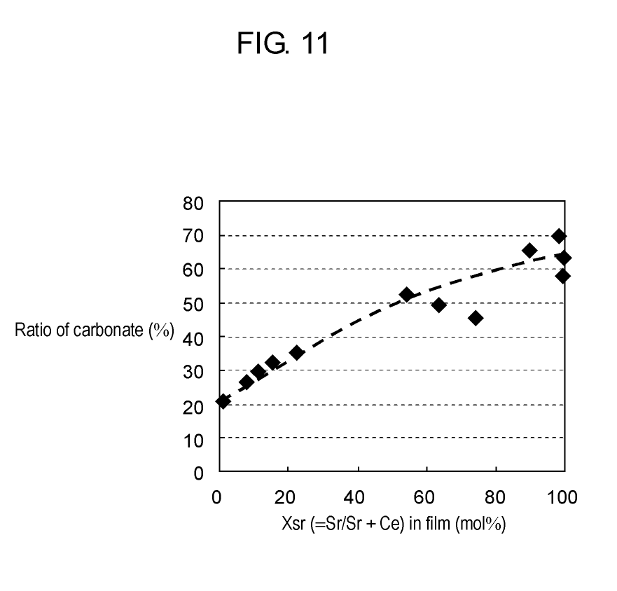

A graph obtained through XPS measurements on the basis of the above-mentioned conditions and plotting the ratios of a carbonate to the surface is shown in FIG. 11.

From the position of the curve shown in FIG. 11, it can be desirable to reduce X_{Sr} to approximately 50 mol % or less for ensuring that at least the ratio of the carbonate to the protective film is 50 mol % or less.

It has been found from this result that the upper limit of X_{Sr} in the protective film is preferably 50 mol % or less for carrying out the aging step in short time with inclusion of impurities in the protective film being suppressed wherever possible.

Experiment 3

Evaluation of Discharge Properties

(Discharge Voltage)

For examining the properties of operating voltages of the samples described above, the samples, and a PDP using as a discharge gas a Xe—Ne mixed gas having a Xe partial pressure of 15% were prepared, and discharge sustain voltages were measured.

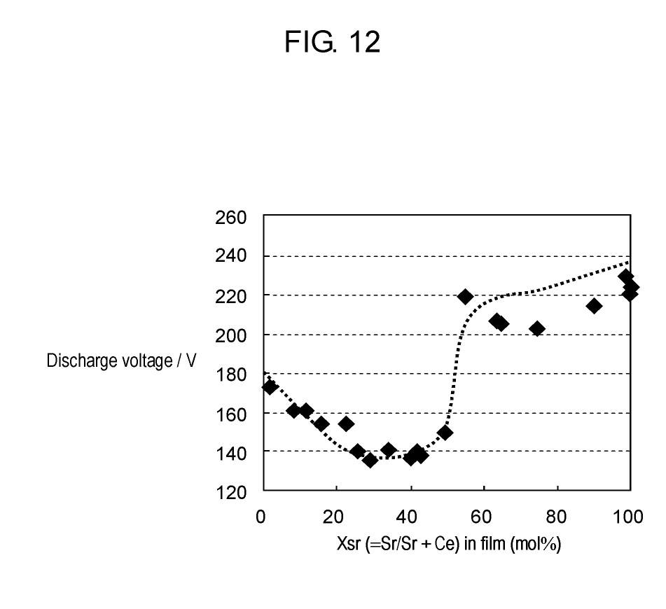

FIG. 12 is a graph obtained by plotting behaviors of discharge sustain voltages to X_{Sr} in the film measured under the conditions described above.

As shown in FIG. 12 and Table 1, it has been found that if X_{Sr} is set to 11.8 mol % to 49.4 mol % inclusive, a discharge sustain voltage that is originally about 175 V decreases to 160 V or less, and therefore low power driving is promoted. Moreover, it is considered that when X_{Sr} is in a range of 25.7 mol % to 42.9 mol % inclusive, the discharge voltage decreases to about 150 V, and therefore still further low power driving is possible.

As the reason why these results were obtained, it is considered that addition of an appropriate amount of Sr could contribute to reduction of the discharge voltage by forming a Sr-originated impurity level in a forbidden band and raising the position of a valence band, resulting in improvement of secondary electron emission property of the protective film.

It can be found that conversely the discharge voltage increases if X_{Sr} is more than 49.4 mol %. This is considered to be because the phase state is changed to a structure having principally SrO, and the protective film is contaminated by, for example, formation of undesired Sr(OH)₂ on the protective film in a panel production process as described above.

For summarizing these results, it is seen that it is not desirable to include a too large amount of St in the protective film, and there is an appropriate concentration range.

It is seen that as shown in Table 3, samples 21, 23 and 24 having fine particles of SrCeO₃ and La₂Ce₂O₇, respectively, in a protective film having X_{Sr} of 42.9 mol % have a low voltage like sample 10 having no fine particles. This is considered to be because the secondary electron emission property of high γ fine particles are comparable to those of the underlying protective film, and therefore an increase in discharge voltage is not caused. On the other hand, it is seen that sample 22 having BaceO₃ arranged on a protective film having X_{Sr} of 42.9 mol % has a discharge voltage lower by 17 V than that of sample 10. This is considered to be because fine particles of BaCeO₃ have second electron emission property higher than those of the underlying protective film, and the secondary electron emission property of the protective film in general are improved.

(Aging Behavior)

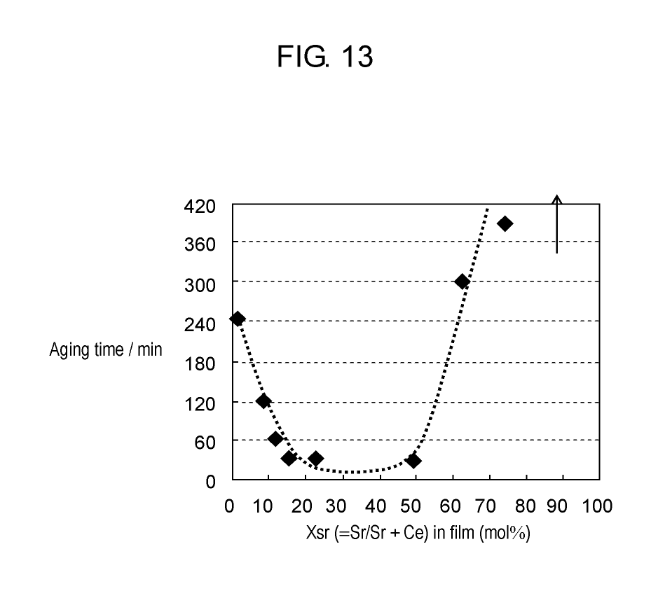

Next, a dependency on X_{Sr} of the aging time for a PDP using each sample is shown in FIG. 13 and Tables 1 to 3. The “aging time” herein refers to a time taken for the discharge voltage to be saturated after an aging step is started, i.e., a time taken until achievement of a voltage higher by 5% than a bottom voltage that is the lowest voltage.

It is seen from FIG. 13 that when X_{Sr} is in a range corresponding to Reference Examples 1 to 10 (11.8 mol % to 49.4 mol % inclusive), it takes only 120 minutes or shorter for aging to be completed, whereas the aging time is about 240 minutes when using a protective film composed of CeO₂. Further, when X_{Sr} is particularly in a range of 25.7 mol % to 42.9 mol % inclusive (Reference Examples 4 to 9), the aging time can be reduced to about 20 minutes, thus being preferred.

This is considered to be because in usual CeO₂, emission of electrons from an electronic level existing in a forbidden band is dominant, and it takes a long time for the emission of electrons to become stable, whereas if Sr is appropriately added with X_{Sr} being in a range of 11.8 mol % to 49.4 mol % inclusive, stable emission of electrons from a valence band, the upper end position of which is raised, becomes dominant, and the aging time is accordingly reduced.

From the results shown in FIG. 13 and Tables 1 to 3, the concentration of Sr added is preferably such that X_{Sr} is 25.7 mol % to 42.9 mol % inclusive in terms of the aging time as well.

(Measurement of Discharge Delay)

Next, the degree of the discharge delay in address discharge was evaluated using a discharge gas similar to that described above and for samples 11 and 24 having MgO fine particles arranged on a protective film. As a method for evaluation thereof, a pulse corresponding to the initializing pulse of the drive waveform example shown in FIG. 3 was applied to any one cell in a PDP using each of all samples 1 to 24, followed by measuring a statistic delay generated when applying a data pulse and a scan pulse.

As a result, it was found that in samples 11 and 24 having MgO fine particles arranged therein, the discharge delay was effectively reduced as compared to other samples, i.e., samples 1 to 10 and 12 to 23.

Thus, the effect of preventing the discharge delay in the PDP is further improved by arranging MgO fine particles, but the effect is more significant with MgO fine particles prepared by a precursor firing method than with MgO fine particles prepared by a gas phase method. Therefore, it can be said that the precursor firing method is a method for preparation of MgO fine particles which is suitable for the present invention.

As shown by experimental data for samples 11 and 24 described above, it has been found that dispersive arrangement of MgO fine particles on the surface of a protective film having a predetermined concentration of Sr can provide a PDP which is driven at a low power and has a reduced discharge delay.

(Measurement of Efficiency)

Next, emission efficiency as a panel was evaluated using as a discharge gas a gas containing Xe at a partial pressure of 20% and for sample 9 having a protective film having X_{Sr} of 42.9 mol % and sample 21 having fine particles of SrCeO₃ arranged on the protective film. As a method for evaluation thereof, a measurement was made of emission efficiency obtained when a pulse corresponding to the sustain pulse of the drive waveform example shown in FIG. 3 was applied to a discharge region (lit region) of an arbitrary area in a PDP using each sample.

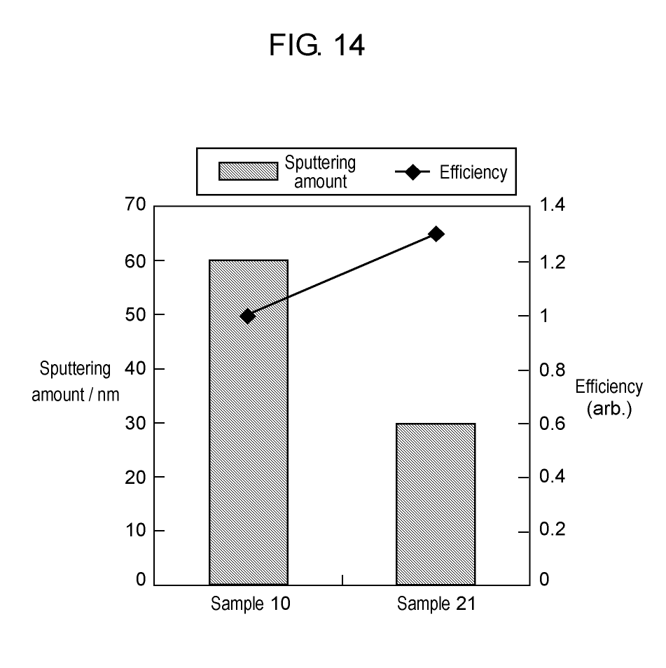

The results are shown in FIG. 14. The value of emission efficiency is represented such that value of emission efficiency of sample 9 is 1. As in the figure, it has been found that arrangement of fine particles of SrCeO₃ increases emission efficiency by a factor of 1.3 or more. This is considered to be because by arranging high γ fine particles having high secondary electron emission property, localized discharge regions are expanded, so that Xe is efficiently excited and vacuum ultraviolet light is increased.

As shown by experimental data of samples 9 and 24 described above, it has been found that dispersive arrangement of fine particles having high secondary electron emission property on the surface of a protective film having a predetermined concentration of Sr provides a PDP which is driven at a low power and has a high luminance and high efficiency.

(Measurement of Reliability—Measurement of Sputtering Resistance)

Next, reliability when carrying out discharge for a long time was evaluated using as a discharge gas a gas containing Xe at a partial pressure of 30% and for sample 9 having a protective film having X_{Sr} of 42.9 mol % and sample 21 having fine particles of SrCeO₃ arranged on the protective film. As a method for evaluation thereof, a measurement was made of a depth of sputtering by ions at the time of discharge when a pulse corresponding to the sustain pulse of the drive waveform example shown in FIG. 3 was applied to any cell in a PDP using each sample for 1000 hours.

The results are shown in FIG. 14. As in the figure, it has been found that arrangement of fine particles of SrCeO₃ reduces the sputtering amount to ½. Also for this phenomenon, it is considered that by arranging high γ fine particles having high secondary electron emission property, localized discharge regions are expanded, so that localized sputtering is suppressed, sputtering spreads over a wide range, and progression in the depth direction is suppressed.

As shown by experimental data of samples 9 and 24 described above, it has been found that dispersive arrangement of fine particles having high secondary electron emission property on the surface of a protective film having a predetermined concentration of Sr provides a PDP which is driven at a low power and has high reliability.

### INDUSTRIAL APPLICABILITY

The PDP of the present invention can be applied to, for example, gas discharge panels which display high definition dynamic images by low power driving. In addition, the PDP of the present invention can be applied to information displaying devices in transportation and public facilities, or television devices or computer displays in households, workplaces and the like.

### REFERENCE MARKS IN THE DRAWINGS

1, 1a, 1x PDP
2 front panel
3 front panel glass
4 sustain electrode
5 scan electrode
6 display electrode pair
7, 12 dielectric layer
8 protective film (high γ film)
9 back panel
10 back panel glass
11 data (address) electrode
13 barrier rib
14, 14R, 14G, 14B phosphor layer
15 discharge space
16 MgO fine particles
17 high γ fine particles (high γ fine particles containing Ce, Sr, Ba)
81 deterioration layer

TABLE 1

| | Concentration | | | | | | | |
|---|---|---|---|---|---|---|---|---|
| | of Sr in film, | | | | | Discharge | | |
| | X_{Sr} Sr/ | | MgO | Oxide | Ratio of | voltage (V) | Aging | |
| | (Sr + Ce) * 100 | Phase | fine | fine | carbonate | (Xe 15% | time | Discharge |
| | (mol %) | state | particles | particles | (%) | 450 torr) | (min) | delay |
| Sample 1 | 11.8 | CeO₂ | Absent | Absent | 29.8 | 161 | 60 | Δ |
| (Reference | | | | | | | | |
| example 1) | | | | | | | | |
| Sample 2 | 15.7 | CeO₂ | Absent | Absent | 32.4 | 154 | 30 | Δ |
| (Reference | | | | | | | | |
| example 2) | | | | | | | | |
| Sample 3 | 22.7 | CeO₂ | Absent | Absent | 35.3 | 154 | 30 | Δ |
| (Reference | | | | | | | | |
| example 3) | | | | | | | | |
| Sample 4 | 25.7 | CeO₂ | Absent | Absent | | 140 | 30 | Δ |
| (Reference | | | | | | | | |
| example 4) | | | | | | | | |
| Sample 5 | 29.0 | CeO₂ | Absent | Absent | | 136 | 30 | Δ |
| (Reference | | | | | | | | |
| example 5) | | | | | | | | |
| Sample 6 | 34.2 | CeO₂ | Absent | Absent | | 141 | 30 | Δ |
| (Reference | | | | | | | | |
| example 6) | | | | | | | | |
| Sample 7 | 40.0 | CeO₂ | Absent | Absent | | 137 | 30 | Δ |
| (Reference | | | | | | | | |
| example 7) | | | | | | | | |
| Sample 8 | 42.1 | CeO₂ | Absent | Absent | | 140 | 30 | Δ |
| (Reference | | | | | | | | |
| example 8) | | | | | | | | |
| Sample 9 | 42.9 | CeO₂ | Absent | Absent | | 138 | 30 | Δ |
| (Reference | | | | | | | | |
| example 9) | | | | | | | | |
| Sample 10 | 49.4 | CeO₂ | Absent | Absent | | 150 | 30 | Δ |
| (Reference | | | | | | | | |
| example 10) | | | | | | | | |
| Sample 11 | 49.4 | CeO₂ | Present | Absent | | 151 | 30 | ◯ |
| (Reference | | | | | | | | |
| example 11) | | | | | | | | |

TABLE 2

| | Concentration | | | | | | | |
|---|---|---|---|---|---|---|---|---|
| | of Sr | | | | | | | |
| | in film, | | | | | | | |
| | X_{Sr} Sr/ | | | | | Discharge | | |
| | (Sr + Ce) * | | MgO | Oxide | Ratio of | voltage (V) | | |
| | 100 | Phase | fine | fine | carbonate | (Xe 15% | Aging time | Discharge |
| | (mol %) | state | particles | particles | (%) | 450 torr) | (min) | delay |
| Sample 12 | — | MgO | Absent | Absent | — | 185 | 30 | Δ |
| (Comparative | | | | | | | | |
| example 1) | | | | | | | | |
| Sample 13 | 1.6 | CeO₂ | Absent | Absent | 21.2 | 173 | 240 | X |
| (Comparative | | | | | | | | |
| example 2) | | | | | | | | |
| Sample 14 | 8.4 | CeO₂ | Absent | Absent | 26.7 | 161 | 120 | Δ |
| (Comparative | | | | | | | | |
| example 3) | | | | | | | | |
| Sample 15 | 54.9 | Amorphous | Absent | Absent | 52.5 | 219 | Not | X |
| (Comparative | | | | | | | completed | |
| example 4) | | | | | | | in 7 hours | |
| Sample 16 | 63.9 | SrO | Absent | Absent | 49.7 | 206 | Not | X |
| (Comparative | | | | | | | completed | |
| example 5) | | | | | | | in 7 hours | |
| Sample 17 | 90.1 | SrO | Absent | Absent | 66.4 | 215 | Not | X |
| (Comparative | | | | | | | completed | |
| example 6) | | | | | | | in 7 hours | |
| Sample 18 | 98.7 | SrO + | Absent | Absent | 70.1 | 230 | Not | X |
| (Comparative | | Sr(OH)₂ | | | | | completed | |
| example 7) | | | | | | | in 7 hours | |
| Sample 19 | 99.7 | Sr(OH)₂ | Absent | Absent | 58.5 | 221 | Not | X |
| (Comparative | | | | | | | completed | |
| example 8) | | | | | | | in 7 hours | |
| Sample 20 | 100.0 | Sr(OH)₂ | Absent | Absent | 64.1 | 225 | Not | X |
| (Comparative | | | | | | | completed | |
| example 9) | | | | | | | in 7 hours | |

TABLE 3

| | Concentration | | | | | Discharge | | |
|---|---|---|---|---|---|---|---|---|
| | of Sr in film, | | | | | voltage | | |
| | X_{Sr} Sr/ | | MgO | Oxide | Ratio of | (V) | Aging | |
| | (Sr + Ce) * 100 | Phase | fine | fine | carbonate | (Xe 15% | time | Discharge |
| | (mol %) | state | particles | particles | (%) | 450 torr) | (minutes) | delay |
| Sample 21 | 42.9 | CeO₂ | Absent | SrCeO₃ | | 131 | | Δ |
| (Example 1) | | | | | | | | |
| Sample 22 | 42.9 | CeO₂ | Absent | BaCeO₃ | | 121 | | Δ |
| (Example 2) | | | | | | | | |
| Sample 23 | 42.9 | CeO₂ | Absent | La₂Ce₂O₇ | | 138 | | Δ |
| (Example 3) | | | | | | | | |
| Sample 24 | 42.9 | CeO₂ | Present | SrCeO₃ | | 133 | | ◯ |
| (Example 4) | | | | | | | | |

1-8. (canceled)

9. A plasma display panel comprising:
a first substrate on which a plurality of display electrodes is arranged; and
a second substrate,
the first substrate being placed opposite to the second substrate with a discharge space interposed therebetween,
the first substrate and the second substrate being sealed with the discharge space filled with a discharge gas,
wherein the first substrate has a protective film disposed on a surface facing the discharge space, the protective film made of CeO₂ having Sr added to a concentration of 11.8 mol % to 49.4 mol % inclusive is formed, and
the protective film is provided thereon with high γ fine particles having secondary electron emission property higher than secondary electron emission property of the protective film,
and the high γ fine particles contain at least any of Ce, Sr, and Ba.

10. The plasma display panel according to claim 9, wherein
the concentration of Sr in the protective film is 25.7 mol % to 42.9 mol % inclusive.

11. The plasma display panel according to claim 9, wherein
the high γ fine particles are composed of any of SrCeO₃, BaCeO₃, and La₂Ce₂O₇.
